(19) United States
(12) Patent Application Publication
(10) Pub. No.: US 2026/0195575 A1
(43) Pub. Date: Jul. 9, 2026

(54) PREEMPTIVELY CONCLUDING INFERENCE OPERATIONS BASED ON TEST DATA PERFORMANCE

(71) Applicant: INTERNATIONAL BUSINESS MACHINES CORPORATION, ARMONK, NY (US)

(72) Inventors: ANDREW CHRISTIAN MORRELL HICKS, HIGHLAND, NY (US); JEFFREY WILLOUGHBY, POUGHKEEPSIE, NY (US); KHAALID PERSAUD JUGGAN MCMILLAN, HAVERSTRAW, NY (US)

(21) Appl. No.: 19/011,222

(22) Filed: Jan. 6, 2025

(51) Int. Cl. G06N 3/048

(52) U.S. Cl. CPC G06N 3/048

(57) ABSTRACT

Preemptively concluding inference operations based on test data performance, including: detecting, during an inference operation of a neural network, an activation of a grandmother neuron of the neural network, wherein the grandmother neuron comprises a neuron of the neural network always activated for a particular output during training of the neural network and never activated for any other output during training of the neural network; suspending, in response to activation of the grandmother neuron, the inference operation; and providing the particular output as an output of the inference operation.

### BACKGROUND

The present disclosure relates to methods, apparatus, and products for preemptively concluding inference operations based on test data performance.

### SUMMARY

According to embodiments of the present disclosure, various methods, apparatus and products for preemptively concluding inference operations based on test data performance are described herein. In some aspects, preemptively concluding inference operations based on test data performance includes detecting, during an inference operation of a neural network, an activation of a grandmother neuron of the neural network, wherein the grandmother neuron comprises a neuron of the neural network always activated for a particular output during training of the neural network and never activated for any other output during training of the neural network; suspending, in response to activation of the grandmother neuron, the inference operation; and providing the particular output as an output of the inference operation. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a diagram of an example computing environment for preemptively concluding inference operations based on test data performance in accordance with some embodiments of the present disclosure.

FIG. 2 sets forth a flowchart of an example method of preemptively concluding inference operations based on test data performance in accordance with some embodiments of the present disclosure.

FIG. 3 sets forth a flowchart of another example method of preemptively concluding inference operations based on test data performance in accordance with some embodiments of the present disclosure.

FIG. 4 sets forth a flowchart of another example method of preemptively concluding inference operations based on test data performance in accordance with some embodiments of the present disclosure.

FIG. 5 sets forth a flowchart of another example method of preemptively concluding inference operations based on test data performance in accordance with some embodiments of the present disclosure.

FIG. 6 sets forth a flowchart of another example method of preemptively concluding inference operations based on test data performance in accordance with some embodiments of the present disclosure.

FIG. 7 sets forth a flowchart of another example method of preemptively concluding inference operations based on test data performance in accordance with some embodiments of the present disclosure.

FIG. 8 sets forth a flowchart of another example method of preemptively concluding inference operations based on test data performance in accordance with some embodiments of the present disclosure.

FIG. 9 sets forth a flowchart of another example method of preemptively concluding inference operations based on test data performance in accordance with some embodiments of the present disclosure.

FIG. 10 sets forth a flowchart of another example method of preemptively concluding inference operations based on test data performance in accordance with some embodiments of the present disclosure.

FIG. 11 sets forth a flowchart of another example method of preemptively concluding inference operations based on test data performance in accordance with some embodiments of the present disclosure.

### DETAILED DESCRIPTION

In some aspects, a method may include: detecting, during an inference operation of a neural network, an activation of a grandmother neuron of the neural network, wherein the grandmother neuron comprises a neuron of the neural network always activated for a particular output during training of the neural network and never activated for any other output during training of the neural network; suspending, in response to activation of the grandmother neuron, the inference operation; and providing the particular output as an output of the inference operation. This provides the technical advantage of preemptively providing an output corresponding to an activated grandmother neuron instead of completing an inference operation by fully processing an input through a neural network, reducing the amount of time and computational resources required for inference operations, improving system utility and performance.

In some aspects, this method may include detecting, during another inference operation of the neural network, an activation of a plurality of grandmother neurons of the neural network. This provides the technical advantage of identifying erroneously designated grandmother neurons, preventing false positives and improving overall system utility.

In some aspects, this method may include completing the other inference operation by processing an input of the other inference operation beyond the plurality of grandmother neurons of the neural network. This provides the technical advantage of allowing for inference operations to complete in the event that multiple grandmother neurons are activated, improving system utility.

In some aspects, this method may include saving a training data sample for the neural network comprising an input of the other inference operation. This allows for the neural network to be subsequently refined based on data outliers, improving accuracy of the neural network and overall system utility.

In some aspects, this method may include removing a grandmother neuron designation from one or more of the plurality of grandmother neurons. This provides the technical advantage of removing erroneously designated grandmother neurons, preventing potential false positive classifications, improving overall system utility.

In some aspects, this method may include identifying, based on a training of the neural network, one or more neurons of the neural network as one or more grandmother neurons, wherein the grandmother neuron is included in the one or more of grandmother neurons. This provides the technical advantage of identifying grandmother neurons based on neural network training data for later use, improving overall system utility.

In some aspects, detecting the activation of the grandmother neuron comprises monitoring an activation path of the neural network. This provides the technical advantage of allowing for grandmother neuron activations to be monitored without modifying the actual encoding of the neural network, improving system utility.

In some aspects, detecting the activation of the grandmother neuron comprises monitoring a grandmother neuron aggregation layer of the neural network. This provides the technical advantage of monitoring activation of grandmother neurons early in the inference operation, reducing the amount of time required to potentially identify an activated grandmother neuron, thereby improving system performance.

In some aspects, this method may include generating the grandmother neuron aggregation layer. This provides the technical advantage of including a dedicated layer for grandmother neurons in the neural network, reducing the amount of time required to potentially identify an activated grandmother neuron, thereby improving system performance.

In some aspects, this method may include exchanging, in the grandmother neuron aggregation layer, one or more grandmother neurons with one or more other grandmother neurons based on an activation rate of the one of more grandmother neurons. This provides the technical advantage of refining the particular grandmother neurons included in the grandmother neuron aggregation layer to include those grandmother neurons most likely to be activated, improving overall system utility and performance.

In some aspects, a computer system may include: a processor set; one or more computer-readable storage media; and program instructions stored on the one or more storage media to cause the processor set to perform operations comprising: detecting, during an inference operation of a neural network, an activation of a grandmother neuron of the neural network, wherein the grandmother neuron comprises a neuron of the neural network always activated for a particular output during training of the neural network and never activated for any other output during training of the neural network; suspending, in response to activation of the grandmother neuron, the inference operation; and providing the particular output as an output of the inference operation. This provides the technical advantage of preemptively providing an output corresponding to an activated grandmother neuron instead of completing an inference operation by fully processing an input through a neural network, reducing the amount of time and computational resources required for inference operations, improving system utility and performance.

In some aspects, these operations may include detecting, during another inference operation of the neural network, an activation of a plurality of grandmother neurons of the neural network. This provides the technical advantage of identifying erroneously designated grandmother neurons, preventing false positives and improving overall system utility.

In some aspects, these operations may include completing the other inference operation by processing an input of the other inference operation beyond the plurality of grandmother neurons of the neural network. This provides the technical advantage of allowing for inference operations to complete in the event that multiple grandmother neurons are activated, improving system utility.

In some aspects, these operations may include saving a training data sample for the neural network comprising an input of the other inference operation. This allows for the neural network to be subsequently refined based on data outliers, improving accuracy of the neural network and overall system utility.

In some aspects, these operations may include removing a grandmother neuron designation from one or more of the plurality of grandmother neurons. This provides the technical advantage of removing erroneously designated grandmother neurons, preventing potential false positive classifications, improving overall system utility.

In some aspects, these operations may include identifying, based on a training of the neural network, one or more neurons of the neural network as one or more grandmother neurons, wherein the grandmother neuron is included in the one or more of grandmother neurons. This provides the technical advantage of identifying grandmother neurons based on neural network training data for later use, improving overall system utility.

In some aspects, detecting the activation of the grandmother neuron comprises monitoring an activation path of the neural network. This provides the technical advantage of allowing for grandmother neuron activations to be monitored without modifying the actual encoding of the neural network, improving system utility.

In some aspects, detecting the activation of the grandmother neuron comprises monitoring a grandmother neuron aggregation layer of the neural network. This provides the technical advantage of monitoring activation of grandmother neurons early in the inference operation, reducing the amount of time required to potentially identify an activated grandmother neuron, thereby improving system performance.

In some aspects, these operations may include generating the grandmother neuron aggregation layer. This provides the technical advantage of including a dedicated layer for grandmother neurons in the neural network, reducing the amount of time required to potentially identify an activated grandmother neuron, thereby improving system performance.

In some aspects, these operations may include exchanging, in the grandmother neuron aggregation layer, one or more grandmother neurons with one or more other grandmother neurons based on an activation rate of the one of more grandmother neurons. This provides the technical advantage of refining the particular grandmother neurons included in the grandmother neuron aggregation layer to include those grandmother neurons most likely to be activated, improving overall system utility and performance.

In some aspects, a computer program product may include: one or more computer-readable storage media; and program instructions stored on the one or more storage media to perform operations comprising: detecting, during an inference operation of a neural network, an activation of a grandmother neuron of the neural network, wherein the grandmother neuron comprises a neuron of the neural network always activated for a particular output during training of the neural network and never activated for any other output during training of the neural network; suspending, in response to activation of the grandmother neuron, the inference operation; and providing the particular output as an output of the inference operation.

This provides the technical advantage of preemptively providing an output corresponding to an activated grandmother neuron instead of completing an inference operation by fully processing an input through a neural network, reducing the amount of time and computational resources required for inference operations, improving system utility and performance.

In some aspects, these operations may include detecting, during another inference operation of the neural network, an activation of a plurality of grandmother neurons of the neural network. This provides the technical advantage of identifying erroneously designated grandmother neurons, preventing false positives and improving overall system utility.

In some aspects, these operations may include completing the other inference operation by processing an input of the other inference operation beyond the plurality of grandmother neurons of the neural network. This provides the technical advantage of allowing for inference operations to complete in the event that multiple grandmother neurons are activated, improving system utility.

In some aspects, these operations may include saving a training data sample for the neural network comprising an input of the other inference operation. This allows for the neural network to be subsequently refined based on data outliers, improving accuracy of the neural network and overall system utility.

In some aspects, these operations may include removing a grandmother neuron designation from one or more of the plurality of grandmother neurons. This provides the technical advantage of removing erroneously designated grandmother neurons, preventing potential false positive classifications, improving overall system utility.

In neuroscience, a grandmother cell is a hypothetical neuron that represents a specific entity, such as an object, person, or concept, that is activated when a person sees or otherwise experiences that specific entity. Particularly, grandmother cells are conceptually activated quickly when that specific entity is experienced, reducing the overall amount of time for a person to recognize that entity compared to other entities.

Neural networks include multiple layers of neurons that may be activated as an input is processed through the neural network as part of an inference operation. If an inference operation can be preemptively suspended or concluded so as to provide some output, the overall amount of time and processing resources required to perform the inference operation is reduced. Accordingly, it may be advantageous to adapt neuroscientific concepts such as the grandmother cell to neural network applications to achieve these performance benefits.

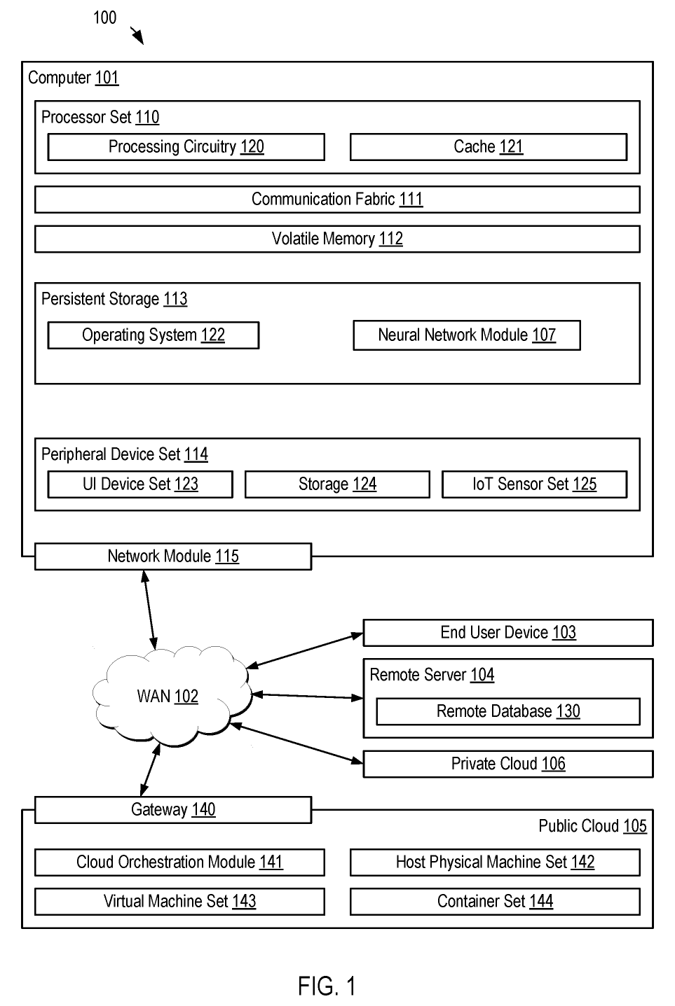

With reference now to FIG. 1, shown is an example computing environment according to aspects of the present disclosure. Computing environment 100 contains an example of an environment for the execution of at least some of the computer code involved in performing the various methods described herein, such as the neural network module 107. In addition to neural network module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and neural network module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in neural network module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in neural network module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

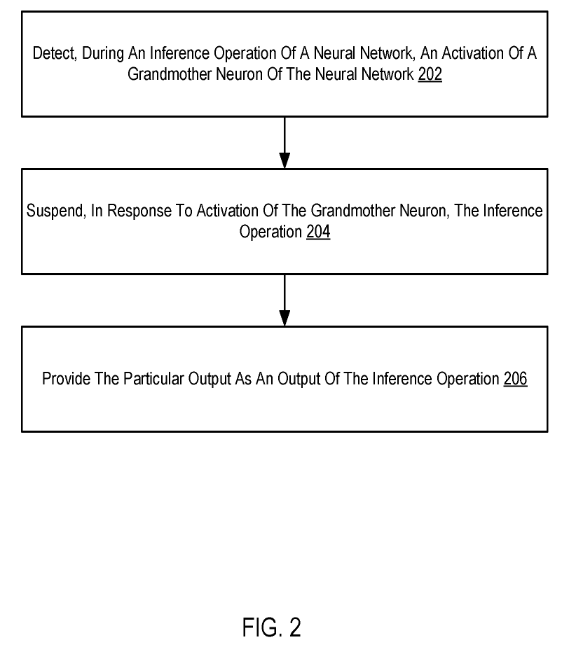

For further explanation, FIG. 2 sets forth a flowchart of an example method of preemptively concluding inference operations based on test data performance in accordance with some embodiments of the present disclosure. The method of FIG. 2 may be performed, for example, by a neural network module 107 of FIG. 1. The method of FIG. 2 includes detecting 202, during an inference operation of a neural network, an activation of a grandmother neuron of the neural network. As described herein, a grandmother neuron is a neuron or node of the neural network that, during training of the neural network, was always activated for a particular output and was never activated for any other output. Put differently, grandmother neurons are neurons that have a one-to-one mapping with particular training data outputs such that any training data output may only be mapped to a single grandmother neuron.

For example, assuming a training data set of input and output pairs with the output value being a particular classification, a grandmother neuron is a neuron that was always activated for training data samples of a particular classification of training data and never activated for any other classification of training data. Continuing with this example, assume that a neural network is being trained on a training data set for classifying images of animals, with each sample of training data including, as input, an image and, as output, a classification of animal. A grandmother neuron may be identified as a neuron that was always activated for samples for cats and not activated for any other classification of animal. Moreover, as grandmother neurons have a one-to-one mapping for particular outputs, only a single node may be identified as a grandmother neuron for cats.

The interference operation of the neural network is any operation whereby some input was provided to the neural network so as to generate some output. This may include, for example, classifications, predictions, or other types of inference operations as can be appreciated. Detecting 202, during the inference operation, an activation of the grandmother neuron includes detecting that a neuron previously identified as a grandmother neuron has been activated in response to some input provided to the neural network. This may include detecting that an identified grandmother neuron has been activated with a confidence value or some other score exceeding a threshold. Particular approaches for detecting 202 activation of the grandmother neuron are described in further detail below.

The method of FIG. 2 also includes suspending 204, in response to an activation of the grandmother neuron, the inference operation. During an inference operation using a neural network, the input to the neural network, after being processed by an input layer, is processed through successive hidden layers until an output layer is reached, with the output layer providing the output of the inference operation. Here, as a grandmother neuron has been activated, it may be determined that no further processing through these layers is required in order to complete the inference operation. Accordingly, the inference operation is suspended 204 so as to prevent or refrain from any further processing through the neural network. In other words, rather than processing the input through the neural network until the output layer is reached so as to generate some output, the inference operation is preemptively suspended or concluded.

The method of FIG. 2 also includes providing 206 the particular output as an output of the inference operation. In other words, after suspending 204 the inference operation, the particular output corresponding to the activate grandmother neuron is provided as output of the inference operation. Thus, rather than fully process some input through all layers of the neural network to complete the inference operation, the inference operation is instead preemptively concluded by providing, as output, the particular output corresponding to the activated grandmother neuron.

Returning to the example where the neural network has been trained to perform classifications of images of animals, assume that, during an inference operation to classify an animal in an image, the grandmother neuron for classifying cats has been activated. As this neuron has only ever been activated for images including cats and never activated for any other classification of animal, it can be assumed that the input image includes a cat. Accordingly, rather than fully process the image through the neural network, the inference operation may be preemptively concluded and a classification for a cat may be provided as the output of the inference operation.

Readers will appreciate that these approaches allow for inference operations that cause a grandmother neuron to be activated to be preemptively concluded so as to provide a predefined or predetermined output for that grandmother neuron. This improves both the speed at generating an output for the inference operation and reduces the overall computational burden associated with the inference operation as fully processing the input through the neural network is not performed, improving overall system performance. Moreover, although the discussion set forth above is described in the context of a single grandmother neuron, readers will appreciate that, in some embodiments, a neural network may potentially include multiple grandmother neurons each corresponding to different outputs.

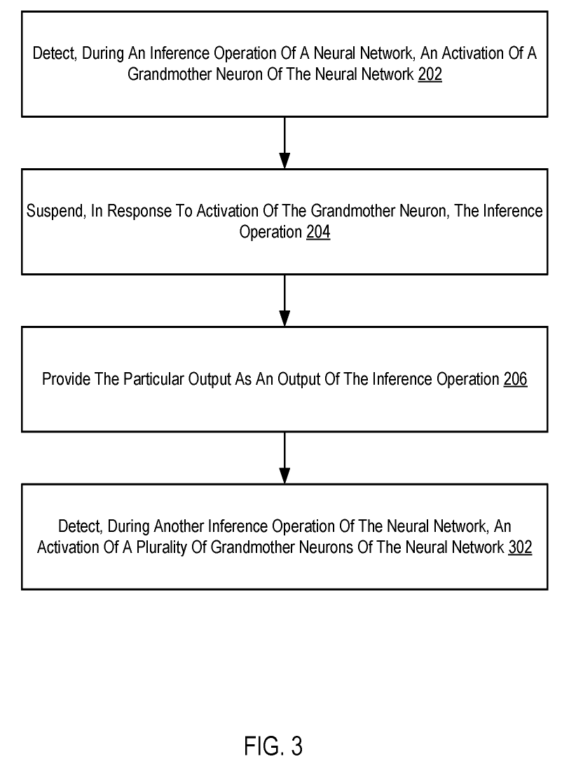

For further explanation, FIG. 3 sets forth a flowchart of another method of preemptively concluding inference operations based on test data performance in accordance with some embodiments of the present disclosure. The method of FIG. 3 is similar to FIG. 2 in that the method of FIG. 3 also includes: detecting 202, during an inference operation of a neural network, an activation of a grandmother neuron of the neural network; suspending 204, in response to an activation of the grandmother neuron, the inference operation; and providing 206 the particular output as an output of the inference operation.

The method of FIG. 3 differs from FIG. 2 in that the method of FIG. 3 also includes: detecting 302, during another inference operation of the neural network, an activation of a plurality of grandmother neurons of the neural network. As is set forth above, a grandmother neuron should only be activated for a particular output and only a single grandmother neuron should be mapped to that particular classification. Accordingly, where an input causes multiple grandmother neurons to be activated, designation of one or more of these neurons as grandmother neurons is erroneous.

Continuing with the example of a neural network for classifying images of animals, assume that an input image causes a first grandmother neuron corresponding to cats and a second grandmother neuron corresponding to dogs to be activated. As the animal in the image cannot be both and a dog simultaneously, both the first and second grandmother neurons were erroneously designated as grandmother neurons. Assuming that the image is actually a cat, the second grandmother neuron should not be a grandmother neuron for dogs as it was activated for an input image of a cat.

As will be described in subsequent flowcharts, various actions may be performed in response to detecting activation of multiple grandmother neurons. This may include, for example, removing a grandmother neuron designation from one or more of the multiple grandmother neurons, saving the input of the other inference operation as a training data sample for later retraining or fine-tuning, and/or completing the other inference operation using the rest of the neural network.

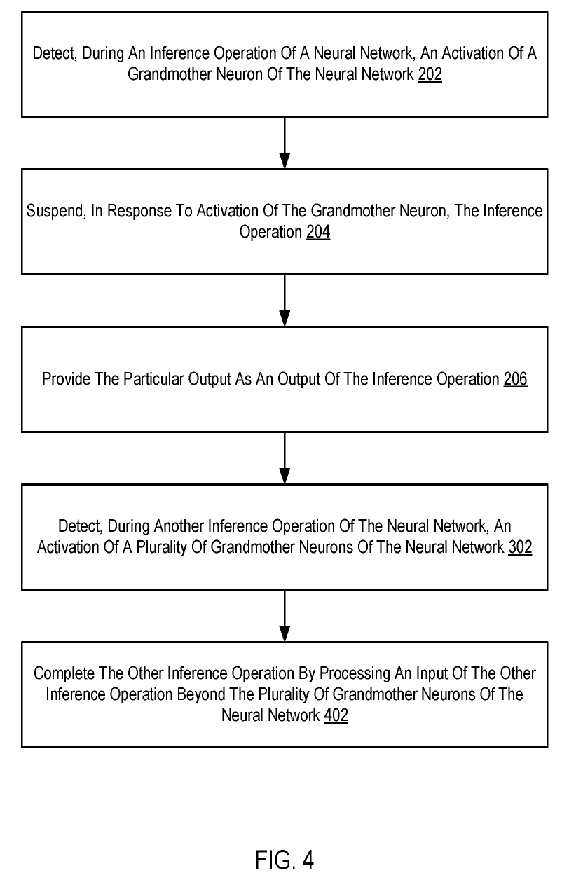

For further explanation, FIG. 4 sets forth a flowchart of another method of preemptively concluding inference operations based on test data performance in accordance with some embodiments of the present disclosure. The method of FIG. 4 is similar to FIG. 3 in that the method of FIG. 4 also includes: detecting 202, during an inference operation of a neural network, an activation of a grandmother neuron of the neural network; suspending 204, in response to an activation of the grandmother neuron, the inference operation; providing 206 the particular output as an output of the inference operation; and detecting 302, during another inference operation of the neural network, an activation of a plurality of grandmother neurons of the neural network.

The method of FIG. 4 differs from FIG. 3 in that the method of FIG. 4 also includes: completing 402 the other inference operation by processing an input of the other input operation beyond the plurality of grandmother neurons of the neural network. In other words, the input to the other input operation may be processed fully through the neural network so as to generate an output for the other inference operation. As multiple grandmother neurons have been activated and their outputs are mutually exclusive, no output corresponding to any of these grandmother neurons may be reliably output by preemptively concluding the other inference operation. Accordingly, to generate an output for the other inference operation, this input is fully processed through the neural network.

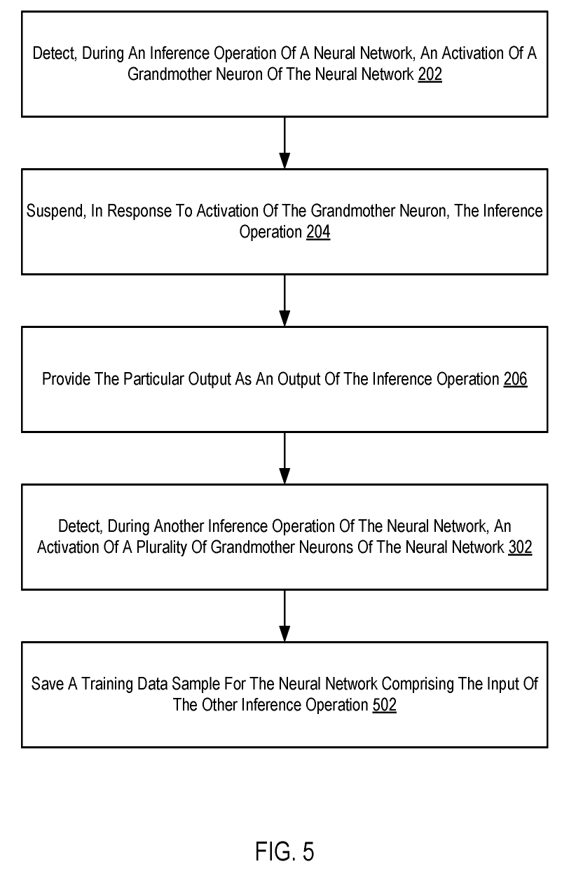

For further explanation, FIG. 5 sets forth a flowchart of another method of preemptively concluding inference operations based on test data performance in accordance with some embodiments of the present disclosure. The method of FIG. 5 is similar to FIG. 3 in that the method of FIG. 5 also includes: detecting 202, during an inference operation of a neural network, an activation of a grandmother neuron of the neural network; suspending 204, in response to an activation of the grandmother neuron, the inference operation; providing 206 the particular output as an output of the inference operation; and detecting 302, during another inference operation of the neural network, an activation of a plurality of grandmother neurons of the neural network.

The method of FIG. 5 differs from FIG. 3 in that the method of FIG. 5 also includes: saving 502 a training data sample for the neural network comprising an input of the other inference operation. As the input of the other inference operation caused activation of multiple grandmother neurons, this input serves as an outlier relative to the existing training data set for the neural network (e.g., the training data set that resulted in identification of these multiple grandmother neurons). Accordingly, this input may be useful as a training data sample so as to prevent subsequent erroneous grandmother neuron designations.

For example, in some embodiments, the training data sample may include, as an input value, the input to the other inference operation. In some embodiments, the training data sample may include, as an output value, an output of the other inference operation generated as described above by fully processing the input value through the neural network. In some embodiments, the training data sample may include, as an output value, a manually defined value based on a manual review of the input value. This training data sample may then be used, along with potentially other training data samples, in a training data set to refine the neural network. For example, in some embodiments, this training data set may be used to fine-tune the neural network. As another example, in some embodiments, this training data set may be used to fully retrain the neural network.

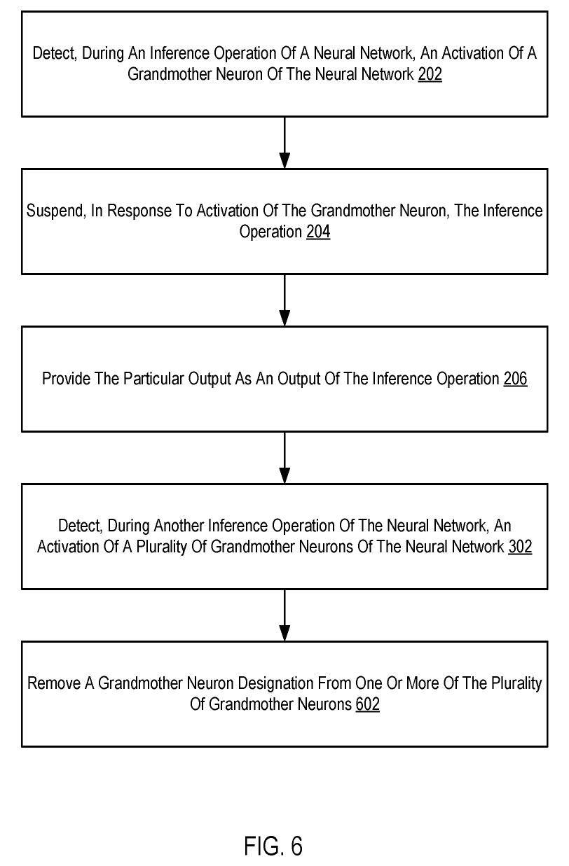

For further explanation, FIG. 6 sets forth a flowchart of another method of preemptively concluding inference operations based on test data performance in accordance with some embodiments of the present disclosure. The method of FIG. 6 is similar to FIG. 3 in that the method of FIG. 6 also includes: detecting 202, during an inference operation of a neural network, an activation of a grandmother neuron of the neural network; suspending 204, in response to an activation of the grandmother neuron, the inference operation; providing 206 the particular output as an output of the inference operation; and detecting 302, during another inference operation of the neural network, an activation of a plurality of grandmother neurons of the neural network.

The method of FIG. 6 differs from FIG. 3 in that the method of FIG. 6 also includes: removing 602 a grandmother neuron designation from one or more of the plurality of grandmother neurons. As multiple grandmother neurons were activated for the same input, one or more of these grandmother neurons were necessarily activated for an input whose output does not match the particular output of the one or more of these grandmother neurons. Returning to the example above, a grandmother neuron for dogs may have been activated for a cat. Accordingly, one or more of these grandmother neurons can no longer be considered a grandmother neuron for preemptively concluding an inference operation and using the particular output of the activated grandmother neuron as the output of the inference operation. Accordingly, removing 602 a grandmother neuron designation for a particular grandmother neuron causes the particular grandmother neuron to no longer being monitored during inference operations of the neural network. In other words, removing 602 a grandmother neuron designation for a particular neuron causes the particular neuron to no longer be treated as a grandmother neuron.

In some embodiments, removing 602 a grandmother neuron designation from one or more of the plurality of grandmother neurons may include removing 602 a grandmother neuron designation for any activated grandmother neuron whose corresponding output does not match the output of the other inference operation. Returning to the examples above, assume that an output of the other inference operation is generated using similar approaches as are set forth above by fully processing the other input through the neural network, resulting in an output of a cat. In this example, the grandmother neuron designation for the grandmother neuron corresponding to the dog output may be removed 602 while maintaining the grandmother neuron designation for the grandmother neuron corresponding to the cat output may be maintained as it matches the output produced by the neural network.

In some embodiments, the grandmother neuron designation may be removed 602 for all of the activated grandmother neurons. In some embodiments, the grandmother neuron designation may be removed 602 for all of the activated grandmother neurons due to the output of the other input operation not matching the corresponding output of any activated grandmother neuron. For example, assume that the neural network produces, for the other input, a classification of a capybara. As this matches the corresponding outputs for neither the dog grandmother neuron nor the cat grandmother neuron, both of their grandmother neuron designations may be removed. In some embodiments, the grandmother neuron designation may be removed 602 for all of the activated grandmother neurons regardless or independent of the output of the other inference operation produced by the neural network.

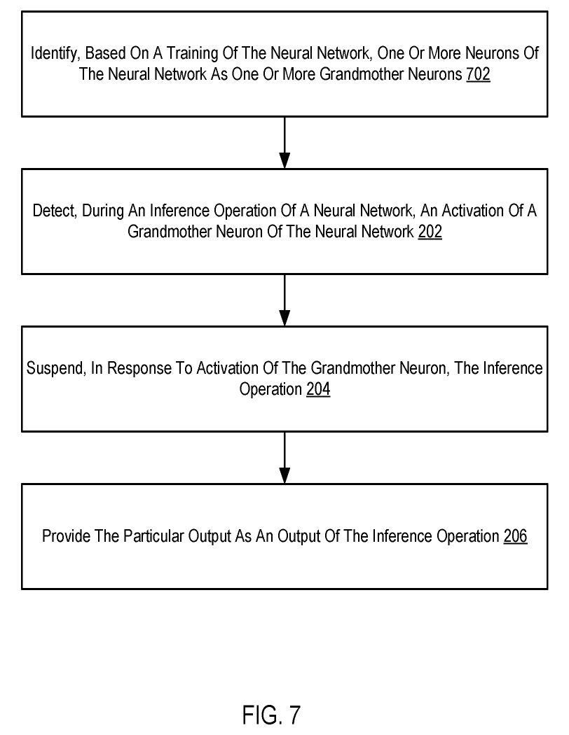

For further explanation, FIG. 7 sets forth a flowchart of another method of preemptively concluding inference operations based on test data performance in accordance with some embodiments of the present disclosure. The method of FIG. 7 is similar to FIG. 2 in that the method of FIG. 7 also includes: detecting 202, during an inference operation of a neural network, an activation of a grandmother neuron of the neural network; suspending 204, in response to an activation of the grandmother neuron, the inference operation; and providing 206 the particular output as an output of the inference operation.

The method of FIG. 7 differs from FIG. 2 in that the method of FIG. 7 also includes: identifying 702, based on a training of the neural network, one or more neurons of the neural network as one or more grandmother neurons. In some embodiments, this may include monitoring an activation path of the neural network during training (e.g., the particular neurons activated during each training data sample). These activation paths may then be used to identify 702 the one or more grandmother neurons according to a variety of approaches.

For example, once training of the neural network has been completed, the activation paths for each training data sample of a particular output may be compared to each other to identify any neurons were always activated for that particular output. These neurons may be identified as candidate grandmother neurons. After identifying any candidate grandmother neurons for each output of the training data, the candidate grandmother neurons for each output may be compared to the activation paths for other outputs to determine if they are included in the activation paths of any other output. Where a candidate grandmother neuron is not found in the activation paths of any other output, the candidate grandmother neuron may be designated as a grandmother neuron. Readers will appreciate that this approach for identifying 702 grandmother neurons is merely illustrative and that other approaches may be used that fall within the scope of the present disclosure.

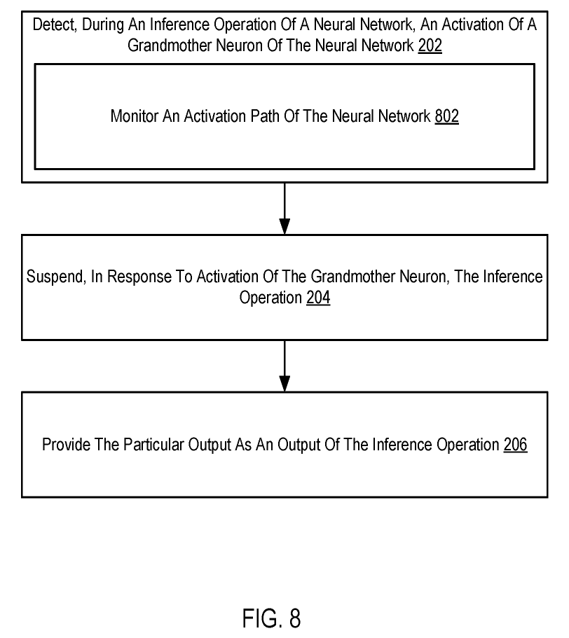

For further explanation, FIG. 8 sets forth a flowchart of another method of preemptively concluding inference operations based on test data performance in accordance with some embodiments of the present disclosure. The method of FIG. 8 is similar to FIG. 2 in that the method of FIG. 8 also includes: detecting 202, during an inference operation of a neural network, an activation of a grandmother neuron of the neural network; suspending 204, in response to an activation of the grandmother neuron, the inference operation; and providing 206 the particular output as an output of the inference operation.

The method of FIG. 8 differs from FIG. 2 in that detecting 202, during an inference operation of a neural network, an activation of a grandmother neuron of the neural network also includes monitoring 802 an activation path of the neural network. In some embodiments, as the input is processed through each layer of the neural network, the activated neurons for a current or most recently processed layer may be compared to a listing of any identified grandmother neurons. If a single identified grandmother neuron has been activated, the inference operation may be suspended 204 and the particular output of the activated grandmother neuron may be provided 206 as output of the inference operation.

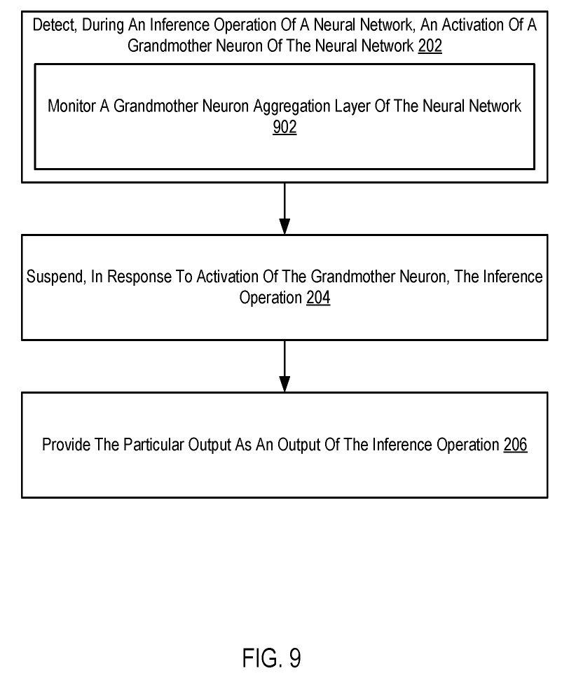

For further explanation, FIG. 9 sets forth a flowchart of another method of preemptively concluding inference operations based on test data performance in accordance with some embodiments of the present disclosure. The method of FIG. 9 is similar to FIG. 2 in that the method of FIG. 9 also includes: detecting 202, during an inference operation of a neural network, an activation of a grandmother neuron of the neural network; suspending 204, in response to an activation of the grandmother neuron, the inference operation; and providing 206 the particular output as an output of the inference operation.

The method of FIG. 9 differs from FIG. 2 in that detecting 202, during an inference operation of a neural network, an activation of a grandmother neuron of the neural network also includes monitoring 902 a grandmother neuron aggregation layer of the neural network. In some embodiments, rather than requiring that activation through the neural network be monitored 802 as described above, a layer may be added early in the neural network, such as a new first hidden layer or another early layer, that includes one or more of the identified grandmother neurons. This may include all of the identified grandmother neurons or a subset thereof. Although the following discussion is presented with respect to a grandmother neuron aggregation layer, other data structures for aggregating identified grandmother neurons may also be used, such as a translation lookaside buffer (TLB).

Accordingly, when processing an input by the neural network, the input is processed first or earlier using this grandmother neuron aggregation layer. Detecting 202 an activation of a grandmother neuron may then include determining if any grandmother neurons in the grandmother neuron aggregation layer are activated. If not, the input is processed through the remaining layers of the neural network. In some embodiments, where the grandmother neuron aggregation layer only includes a subset of identified grandmother neurons, activation of any of the remainder of the identified grandmother neurons may be monitored by monitoring the activation path through the neural network as described above.

Readers will appreciate that the use of a grandmother neuron aggregation layer provides several advantages over approaches that detect 202 activation of grandmother neurons only by monitoring 802 the activation path through the neural network. For example, as the grandmother neuron aggregation layer occurs first or relatively early in the hidden layers of the neural network, activation of grandmother neurons may be detected earlier, thereby allowing for the inference operation to be suspended 202 in response to detecting 202 an activated grandmother neuron, reducing overall computational resource usage and the time to provide the output of the activated grandmother neuron. Moreover, this approach allows for monitoring of a large number of grandmother neurons concurrently by aggregating them into the same layer, in contrast to other approaches where the grandmother neurons may be spread across potentially many hidden layers.

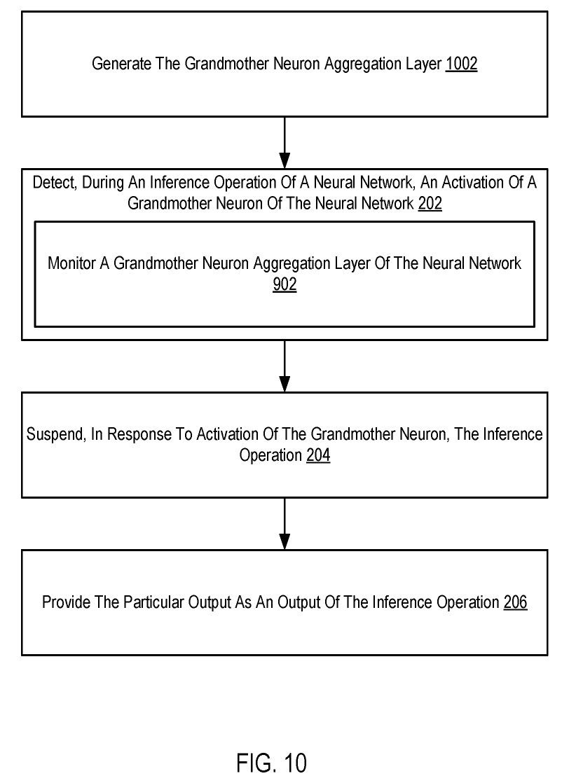

For further explanation, FIG. 10 sets forth a flowchart of another method of preemptively concluding inference operations based on test data performance in accordance with some embodiments of the present disclosure. The method of FIG. 10 is similar to FIG. 9 in that the method of FIG. 10 also includes: detecting 202, during an inference operation of a neural network, an activation of a grandmother neuron of the neural network, including: monitoring 902 a grandmother neuron aggregation layer of the neural network; suspending 204, in response to an activation of the grandmother neuron, the inference operation; and providing 206 the particular output as an output of the inference operation.

The method of FIG. 10 differs from FIG. 9 in that the method of FIG. 10 also includes generating 1002 the grandmother neuron aggregation layer. In some embodiments, generating 1002 the grandmother neuron aggregation layer includes generating 1002 the grandmother neuron aggregation layer to include all identified grandmother neurons. In some embodiments, generating 1002 the grandmother neuron aggregation layer includes generating 1002 the grandmother neuron aggregation layer to include a subset of identified grandmother neurons. For example, in some embodiments, the grandmother neuron aggregation layer may include up to a maximum number of grandmother neurons. Accordingly, in some embodiments, where the number of identified grandmother neurons exceeds the maximum number of grandmother neurons, the grandmother neuron aggregation layer may be generated 1002 to include up to the maximum number of grandmother neurons.

In some embodiments, this subset of identified grandmother neurons may include a random selection of the identified grandmother neurons. In some embodiments, this subset of identified grandmother neurons may correspond to a particular grouping of outputs based on a system or application in which the neural network will be used. For example, where the neural network has been trained on a large set of training data for classifying many types of objects with identified grandmother neurons for different types of objects, assume that the neural network is to be deployed in a system for identifying animals in images. The subset of identified grandmother neurons may then include those grandmother neurons corresponding to different classifications of animals. Readers will appreciate that, in some embodiments, any identified grandmother neurons not in the grandmother neuron aggregation layer may be preserved in the remaining layers of the neural network.

In some embodiments, generating 1002 the grandmother neuron aggregation layer may include removing the grandmother neurons to be included in the grandmother neuron aggregation layer from their original layers in the neural network. In some embodiments, generating 1002 the grandmother neuron aggregation layer may include preserving the grandmother neurons to be included in the grandmother neuron aggregation layer in their original layers in the neural network.

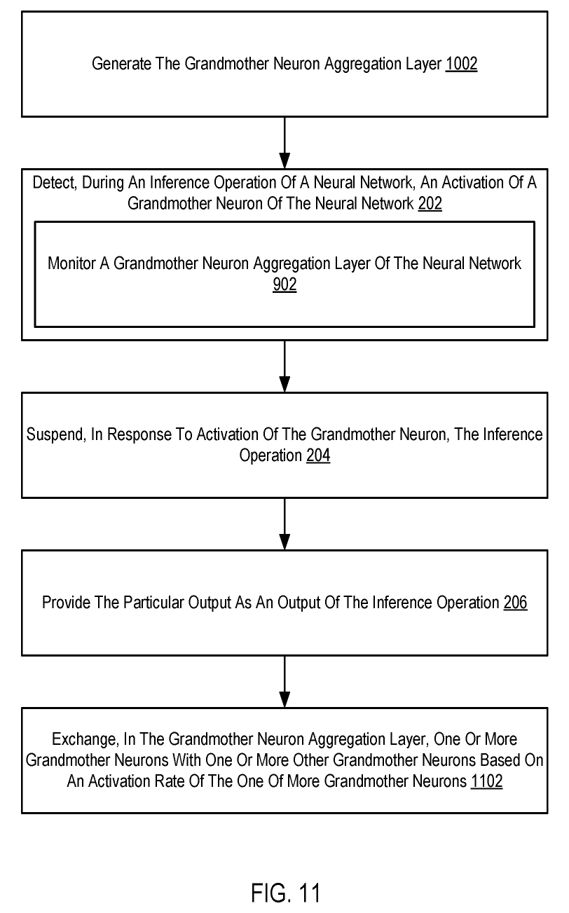

For further explanation, FIG. 11 sets forth a flowchart of another method of preemptively concluding inference operations based on test data performance in accordance with some embodiments of the present disclosure. The method of FIG. 11 is similar to FIG. 10 in that the method of FIG. 11 also includes: generating 1002 the grandmother neuron aggregation layer; detecting 202, during an inference operation of a neural network, an activation of a grandmother neuron of the neural network, including: monitoring 902 a grandmother neuron aggregation layer of the neural network; suspending 204, in response to an activation of the grandmother neuron, the inference operation; and providing 206 the particular output as an output of the inference operation.

The method of FIG. 11 differs from FIG. 10 in that the method of FIG. 11 also includes exchanging 1102, in the grandmother neuron aggregation layer, one or more grandmother neurons with one or more other grandmother neurons based on an activation rate of the one or more grandmother neurons. Although the following discussion describes exchanging 1102 grandmother neurons based on their activation rate, readers will appreciate that other factors or metrics may also be used in exchanging 1102 grandmother neurons. As is set forth above, in some embodiments the grandmother neuron aggregation layer may include only a subset of the identified grandmother neurons, such as where the grandmother neuron aggregation layer includes a maximum number of grandmother neurons. Accordingly, some remainder of identified grandmother neurons may not be monitored when monitoring the grandmother neuron aggregation layer, instead having to monitor the activation path through the neural network to see if any of these remaining identified grandmother neurons are activated.

In some embodiments, the activation rate of the grandmother neurons in the grandmother neuron aggregation layer can be monitored. In response to some event, such as a reaching a predefined time threshold, reaching a predefined number of inference operations, or another event, one or more grandmother neurons may be identified for removal from the grandmother neuron aggregation layer. In some embodiments, the one or more grandmother neurons identified for removal may include those grandmother neurons with an activation rate below some threshold. In some embodiments, the one or more grandmother neurons identified for removal may include the bottom N grandmother neurons in a ranking of grandmother neurons ranked according to their activation rate. In some embodiments, the one or more grandmother neurons may be identified for removal according to other approaches.

These grandmother neurons identified for removal may then be exchanged with a number of grandmother neurons (e.g., a same number of grandmother neurons) not included in the grandmother neuron aggregation layer. Thus, one or more of the grandmother neurons previously not included in the grandmother neuron aggregation layer are added to the grandmother neuron aggregation layer and one or more of the grandmother neurons previously included in the grandmother neuron aggregation layer are removed. In some embodiments, those grandmother neurons removed from the grandmother neuron aggregation layer are instead included in the remaining layers of the neural network.

In some embodiments, the grandmother neurons to be added to the grandmother aggregation layer may also be identified according to a variety of approaches. In some embodiments, the grandmother neurons to be added to the grandmother neuron aggregation layer may include the top N grandmother neurons in a ranking of grandmother neurons not included in the grandmother neuron aggregation layer based on their activation rate, an amount of time or number of inference operations performed while the grandmother neuron has been excluded from the grandmother neuron aggregation layer, or another metric. In some embodiments, the grandmother neurons to be added to the grandmother neuron aggregation layer may include a random selection of grandmother neurons not included in the grandmother neuron aggregation layer. In some embodiments, the grandmother neurons to be added to the grandmother neuron aggregation layer may include a manual selection of grandmother neurons. The grandmother neurons to be added to the grandmother neuron aggregation layer may also be determined or selected according to other approaches.

In embodiments where a grandmother neuron added to the grandmother neuron aggregation layer is removed from its original layer in the neural network, exchanging 1102 the one or more grandmother neurons may include readding, to their original layers of the neural network, those grandmother neurons removed from the grandmother neuron aggregation layer and removing, from their original layers of the neural network, those grandmother neurons added to the grandmother neuron aggregation layer. In embodiments where a grandmother neuron added to the grandmother neuron aggregation layer is preserved in its original layer in the neural network, exchanging 1102 the one or more grandmother neurons includes adding grandmother neurons to and removing grandmother neurons from the grandmother neuron aggregation layer without modifying the grandmother neurons as included in their original layers of the neural network.

For example, assume that, in a neural network used to identify animals from images, a grandmother neuron for identifying capybaras has never been activated in the grandmother neuron aggregation layer. Further assume that, though not included in the grandmother neuron aggregation layer, a grandmother neuron for identifying horses has been activated some number of times. In this example, no performance benefit has been provided by including the capybara grandmother neuron in the grandmother neuron aggregation layer. As the horse grandmother neuron has been activated by some amount, there is likely an unrealized performance benefit for including the horse grandmother neuron ion the grandmother neuron aggregation layer. Accordingly, the capybara grandmother neuron may be exchanged in the grandmother neuron aggregation layer with the horse grandmother neuron.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting, during an inference operation of a neural network, an activation of a grandmother neuron of the neural network, wherein the grandmother neuron comprises a neuron of the neural network always activated for a particular output during training of the neural network and never activated for any other output during training of the neural network;
suspending, in response to activation of the grandmother neuron, the inference operation; and
providing the particular output as an output of the inference operation.

2. The method of claim 1, further comprising detecting, during another inference operation of the neural network, an activation of a plurality of grandmother neurons of the neural network.

3. The method of claim 2, further comprising completing the another inference operation by processing an input of the other inference operation beyond the plurality of grandmother neurons of the neural network.

4. The method of claim 2, further comprising saving a training data sample for the neural network comprising an input of the another inference operation.

5. The method of claim 2, further comprising removing a grandmother neuron designation from one or more of the plurality of grandmother neurons.

6. The method of claim 1, further comprising identifying, based on a training of the neural network, one or more neurons of the neural network as one or more grandmother neurons, wherein the grandmother neuron is included in the one or more grandmother neurons.

7. The method of claim 1, wherein detecting the activation of the grandmother neuron comprises monitoring an activation path of the neural network.

8. The method of claim 1, wherein detecting the activation of the grandmother neuron comprises monitoring a grandmother neuron aggregation layer of the neural network.

9. The method of claim 8, further comprising generating the grandmother neuron aggregation layer.

10. The method of claim 8, further comprising exchanging, in the grandmother neuron aggregation layer, one or more grandmother neurons with one or more other grandmother neurons based on an activation rate of the one of more grandmother neurons.

11. A computer system comprising:
a processor set;
one or more computer-readable storage media; and
program instructions stored on the one or more storage media to cause the processor set to perform operations comprising:
detecting, during an inference operation of a neural network, an activation of a grandmother neuron of the neural network, wherein the grandmother neuron comprises a neuron of the neural network always activated for a particular output during training of the neural network and never activated for any other output during training of the neural network;
suspending, in response to activation of the grandmother neuron, the inference operation; and
providing the particular output as an output of the inference operation.

12. The computer system of claim 11, wherein the operations further comprise detecting, during another inference operation of the neural network, an activation of a plurality of grandmother neurons of the neural network.

13. The computer system of claim 12, wherein the operations further comprise completing the other inference operation by processing an input of the another inference operation beyond the plurality of grandmother neurons of the neural network.

14. The computer system of claim 12, wherein the operations further comprise saving a training data sample for the neural network comprising an input of the another inference operation.

15. The computer system of claim 12, wherein the operations further comprise removing a grandmother neuron designation from one or more of the plurality of grandmother neurons.

16. The computer system of claim 11, wherein the operations further comprise identifying, based on a training of the neural network, one or more neurons of the neural network as one or more grandmother neurons, wherein the grandmother neuron is included in the one or more grandmother neurons.

17. The computer system of claim 11, wherein detecting the activation of the grandmother neuron comprises monitoring an activation path of the neural network.

18. The computer system of claim 11, wherein detecting the activation of the grandmother neuron comprises monitoring a grandmother neuron aggregation layer of the neural network.

19. The computer system of claim 18, wherein the operations further comprise generating the grandmother neuron aggregation layer.

20. The computer system of claim 18, wherein the operations further comprise exchanging, in the grandmother neuron aggregation layer, one or more grandmother neurons with one or more other grandmother neurons based on an activation rate of the one of more grandmother neurons.

21. A computer program product comprising:
one or more computer-readable storage media; and
program instructions stored on the one or more storage media to perform operations comprising:
detecting, during an inference operation of a neural network, an activation of a grandmother neuron of the neural network, wherein the grandmother neuron comprises a neuron of the neural network always activated for a particular output during training of the neural network and never activated for any other output during training of the neural network;
suspending, in response to activation of the grandmother neuron, the inference operation; and
providing the particular output as an output of the inference operation.

22. The computer program product of claim 21, wherein the operations further comprise detecting, during another inference operation of the neural network, an activation of a plurality of grandmother neurons of the neural network.

23. The computer program product of claim 22, wherein the operations further comprise completing the other inference operation by processing an input of the another inference operation beyond the plurality of grandmother neurons of the neural network.

24. The computer program product of claim 22, wherein the operations further comprise saving a training data sample for the neural network comprising an input of the another inference operation.

25. The computer program product of claim 22, wherein the operations further comprise removing a grandmother neuron designation from one or more of the plurality of grandmother neurons.
